(19) United States
(12) Patent Application Publication
(10) Pub. No.: US 2007/0121233 A1
(43) Pub. Date: May 31, 2007

(54) Information recording and reproducing apparatus

(76) Inventors: Takao Sugawara, Kanagawa-ken (JP); Yusuke Kanayama, Kanagawa-ken (JP); Jun Lee, Seongnam-si (KR); Won-choul Yang, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/606,074

(22) Filed: Nov. 30, 2006

(30) Foreign Application Priority Data
Nov. 30, 2005 (JP) 2005-346716
Feb. 1, 2006 (KR) 10-2006-0009814

(51) Int. Cl. G11B 20/10

(52) U.S. Cl. 360/39

(57) ABSTRACT

An information recording and reproducing apparatus which records information on a medium and reproduces information stored on the medium includes a write compensation circuit configured to perform compensation of the information recorded on the medium, wherein the write compensation circuit corrects, in advance, an asymmetry of a signal read from the medium by correcting a write signal in a pulse form along a time axis, and an amount of correction along the time axis is based on information included in the write signal.

### BACKGROUND OF THE INVENTION

1. Field of the Invention

The present invention relates generally to an information recording and reproducing apparatus and, more particularly, to an information recording and reproducing apparatus which includes a write compensation circuit.

A claim of priority is made to Japanese Patent Application No. 2005-346716, filed on Nov. 30, 2005, in the Japanese Patent Office, and Korean Patent Application No. 10-2006-0009814, filed on Feb. 1, 2006, in the Korean Intellectual Property Office, the disclosure of which is incorporated herein in its entirety by reference.

2. Description of the Related Art

Hard disk drives (HDDs) are widely used as an information recording and reproducing apparatus for devices such as, for example, computers. Older HDDs used a longitudinal magnetic recording method. However, these days, a perpendicular magnetic recording method is used instead of the older longitudinal magnetic recording method in HDDs.

In general, a method used by a HDD to read information stored on a storage medium includes the use of a read head for reading a vertical component of a magnetic field associated with magnetized information stored on the storage medium. Specifically, the read head detects this read information as a voltage signal. In some situations, the signal read by the read head may not be suitable. For example, when asymmetry exists in an input/output characteristic or a pH characteristic of the read head, a read signal may become vertically asymmetric. Furthermore, this asymmetry may deteriorate a bit error rate (BER) of the recorded signal. In the conventional longitudinal magnetic recording method, the BER is generally compensated for by an asymmetric correction circuit that is made of a square circuit and an adder. This kind of a circuit is disclosed in Japanese Patent Publication No. 9-320206.

However, the waveform of a read signal in the perpendicular magnetic recording method is different from that of the longitudinal magnetic recording method. This difference in waveforms between the perpendicular magnetic recording method and the longitudinal magnetic recording method requires different treatments for signals read by the read head in each method. Therefore, generally, in the perpendicular magnetic recording method, the read signal is demodulated after it is closely approximated to a corresponding read signal in longitudinal magnetic recording method by filtering it with a nearly differential characteristic. Typically, a high pass filter (HPF) may be used to remove the low frequency component in the signal read by the read head in a perpendicular magnetic recording method.

However, in the perpendicular magnetic recording method, because of the use of the HPF, the asymmetry of the read signal may not be corrected when the filtering is performed before the signal is processed by the asymmetric correction circuit. That is, while correction by the asymmetry correction circuit is possible in the longitudinal magnetic recording method, in the perpendicular magnetic recording method, the asymmetry may not be corrected because of the high cut-off frequency used by the HPF.

The present disclosure is directed towards overcoming one or more problems associated with the conventional information recording and reproducing apparatus.

### SUMMARY OF THE INVENTION

One aspect of the present disclosure includes an information recording and reproducing apparatus which records information on a medium and reproduces information stored on the medium. The apparatus includes a write compensation circuit configured to perform compensation of the information recorded on the medium, wherein the write compensation circuit corrects, in advance, an asymmetry of a signal read from the medium by correcting a write signal in a pulse form along a time axis, and an amount of correction along the time axis is based on information included in the write signal.

Another aspect of the present disclosure includes an information recording and reproducing apparatus which records information on a medium and reproduces information stored on the medium. The apparatus includes a write compensation circuit configured to perform compensation of the information recorded on the medium, wherein the write compensation circuit corrects, in advance, an asymmetry of a signal read from the medium by correcting a write signal in a pulse form along a time axis.

Yet another aspect of the present disclosure includes an information recording and reproducing apparatus which records information on a medium and reproduces information stored on the medium. The apparatus includes a write compensation circuit configured to perform compensation of the information recorded on the medium. The apparatus also includes an MR asymmetry correction circuit configured to correct an asymmetry of a read signal from the medium, wherein the write compensation circuit corrects, in advance, the asymmetry of the signal read from the medium by correcting a write signal in a pulse form along a time axis, an amount of correction along the time axis being based on information included in the write signal, and wherein the MR asymmetry correction circuit corrects the asymmetry of the write signal in combination with the timing correction amount.

Another aspect of the present disclosure includes an information recording and reproducing apparatus which records information on a medium and reproduces information stored on the medium. The apparatus includes a write compensation circuit configured to perform compensation of the information recorded on the medium. The apparatus also includes an MR asymmetry correction circuit configured to correct an asymmetry of a signal read from the medium, wherein the write compensation circuit corrects, in advance, the asymmetry of the signal read from the medium by correcting a write signal in a pulse form along a time axis, and wherein the MR asymmetry correction circuit corrects the asymmetry of the write signal in combination with a timing correction amount generated from the write compensation circuit.

### BRIEF DESCRIPTION OF THE DRAWINGS

The above and other features of the present invention will become more apparent by describing in detail exemplary embodiments thereof with reference to the attached drawings in which:

FIG. 1 is a block diagram showing the flow of recording/reproduction of data in an exemplary disclosed hard disk drive;

FIG. 2 is a graph showing the input/output characteristic (pH characteristic) of a read head;

FIG. 3 is a graph showing the output of the read head in a longitudinal magnetic recording method;

FIG. 4 is a graph showing the output of a high pass filter in the longitudinal magnetic recording method;

FIG. 5 is a graph showing the output of the read head in the perpendicular magnetic recording method;

FIG. 6 is a graph showing the output of a high pass filter with higher cutoff frequency in the perpendicular magnetic recording method;

FIG. 7 is a timing diagram showing an exemplary timing correction of a write compensation circuit;

FIGS. 8 and 9 are graphs showing simulation results of the relationship between the effect of a HPF and the effect of timing correction according to an exemplary disclosed embodiment; and

FIG. 10 is a timing diagram showing exemplary applications of exemplary disclosed embodiments.

### DETAILED DESCRIPTION OF EMBODIMENTS

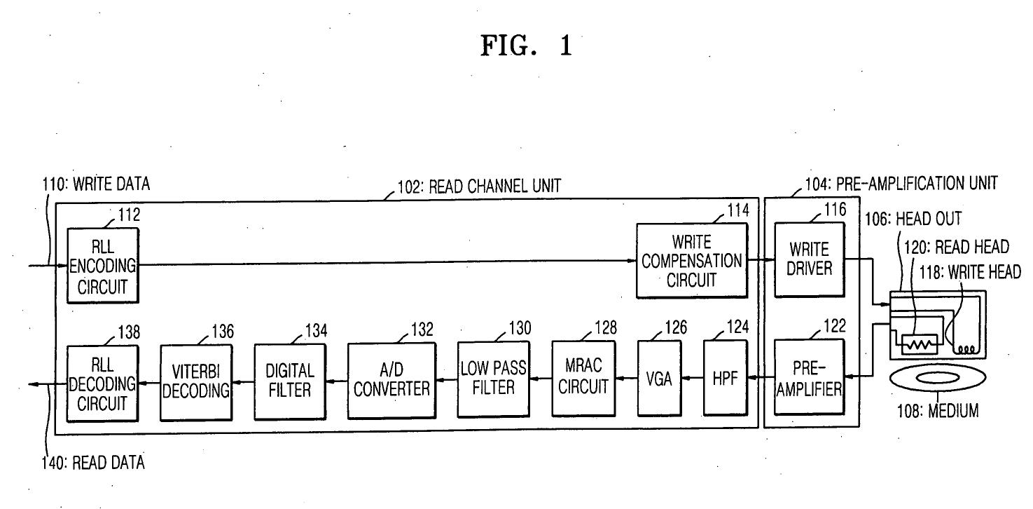

FIG. 1 is a block diagram showing the flow of recording/reproduction of data in a hard disk drive, in which arrows indicate the flow of information. Referring to FIG. 1, a hard disk drive 100 includes a read channel unit 102, a pre-amplification unit 104, and a head unit 106. Specifically, the read channel unit 102 and the pre-amplification unit 104 include integrated circuits having various functions which will be described below. Furthermore, the head unit 106 performs recording and reproduction with respect to a medium 108.

During a recording phase, when a write data 110 is input to the read channel unit 102, a run length limited (RLL) encoding circuit 112 encodes the write data 110. In addition, a write compensation circuit 114 compensates for the timing of a write pulse. In particular, this compensation for the timing of a write pulse is to compensate, in advance, for the shift of magnetism transition when recording. This shift of magnetism transition is referred to as non-linear transition shift (NLTS). The compensated write pulse is then transmitted to the pre-amplification unit 104. In the pre-amplification unit, the write pulse is converted to write current and transmitted to a write head 118 under the control of a write driver 116. Once in the write head 118, the current flows through a coil of the write head 118. In addition, current flowing through the coil generates a magnetic field. Furthermore, magnetic field generated from the coil records data on the medium 108.

During a reproduction phase, a signal reproduced by the read head (or MR head) 120 is amplified by a pre-amplifier 122. Furthermore, this amplified signal is input to a high pass filter (HPF) 124 in the read channel unit 102. While the HPF 124 may perform a variety of functions, the main function of the HPF 124 is to remove a DC component (AC coupling) that may cause electrical problems. Moreover, the HPF 124 is also used to remove thermal asperity (TA) by increasing a cut-off frequency.

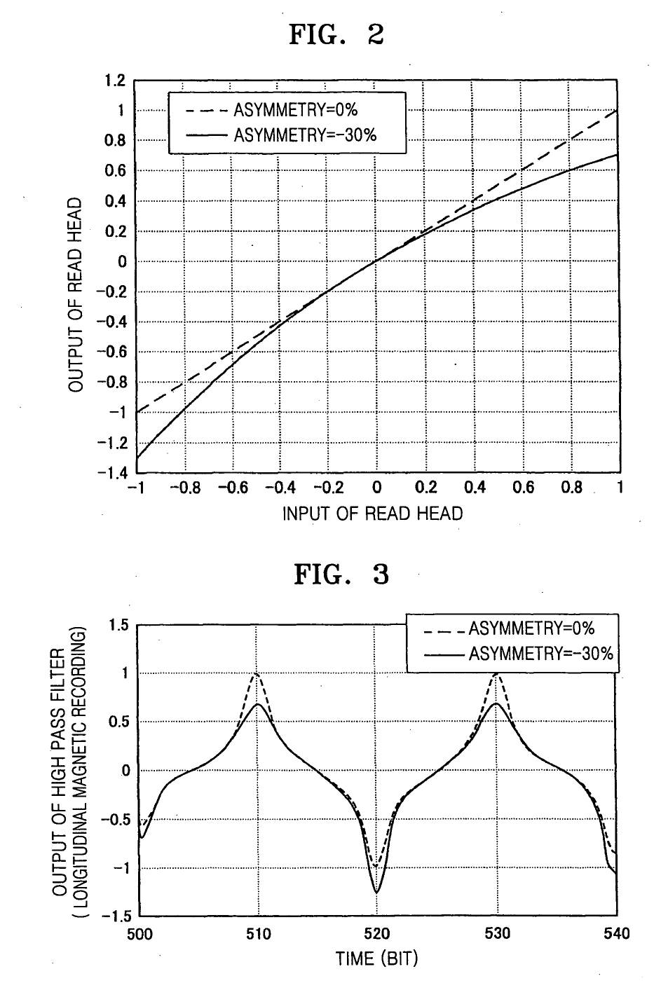

In addition, the reproduced signal may be non-uniform and asymmetric in nature because of issues such as, for example, asymmetry in the input/output characteristics of the read head. To this end, the irregularity of amplitude of the reproduced signal is absorbed by a variable gain amplifier (VGA) 126. In addition, the asymmetry of vertical amplitude of the reproduced signal is corrected by an MR asymmetry correction (MRAC) circuit 128, which will be described in detail with reference to FIG. 2. Furthermore, the noise in a signal whose vertical amplitude asymmetry is corrected by the MRAC circuit 128 is removed by a low pass filter 130. Then, the signal is converted to a digital signal by an analog-to-digital (A/D) converter 132. In addition, the digital signal is converted to a desired form by a digital filter 134 and decoded by a viterbi decoder 136. Next, the digital signal is RLL decoded by an RLL decoding circuit 138 to be output as a read data 140.

FIG. 2 is a graph showing the input/output characteristic (pH characteristic) of a read head. Referring to FIG. 2, the graph shows two different cases: a case in which no asymmetry exists, that is, asymmetry is 0%, which is indicated by a dashed line, and the other case in which asymmetry exists, that is, asymmetry is −30%, which is indicated by a solid line. In the latter case, that is, when the asymmetry is −30%, a solid line graph can be approximated as a quadratic function. Specifically, the asymmetry is formed of the quadratic component. The MRAC circuit 128 is configured to correct this asymmetry. Specifically, the MRAC circuit 128 squares an input signal and removes the quadratic component by adding (or deducting) the squared input signal to (or from) the original input signal, thus correcting the asymmetry.

FIGS. 3 through 6 are graphs showing the results of comparing signal waveforms between a longitudinal magnetic recording (LMR) method and a perpendicular magnetic recording (PMR) method. For example, FIG. 3 is a graph showing the output of the read head in a longitudinal magnetic recording method. In FIG. 3, a dashed line indicates a case in which no asymmetry exists while a solid line indicates a case in which the asymmetry is −30%. As described above, the difference between two cases can be compensated for by the square operation and the adder.

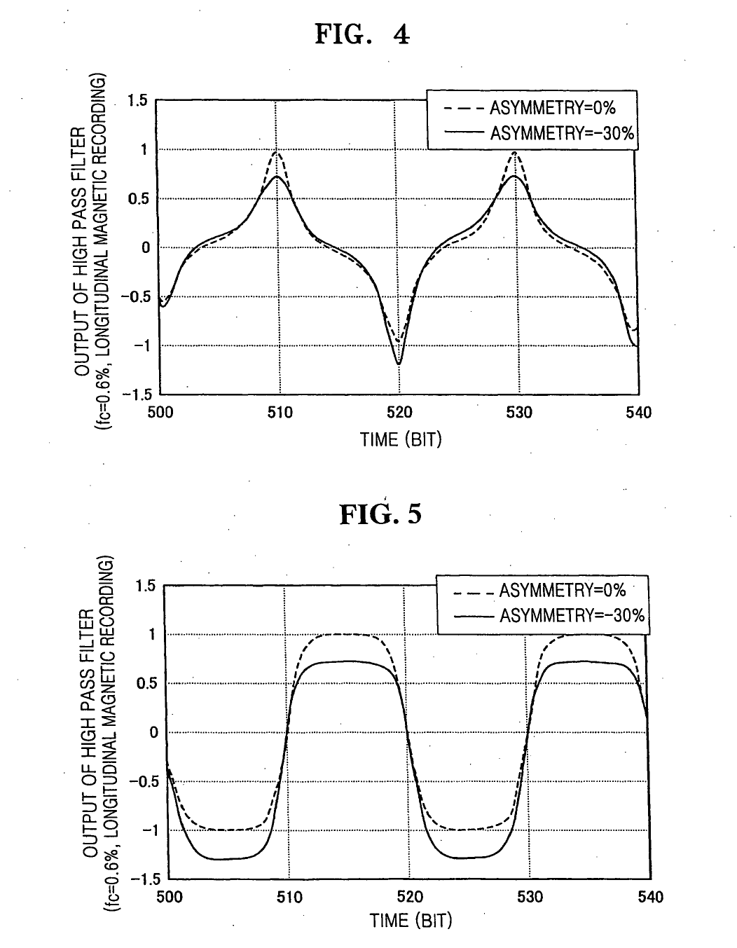

FIG. 4 is a graph showing the output of a high pass filter 124 in the longitudinal magnetic recording method. In FIG. 4, a cut-off frequency is set to 0.6% of a clock frequency (a reciprocal of a bit period). The output of the HPF 124 has almost the same shape as the output of the read head 120 shown in FIG. 3 and can be sufficiently compensated for by the MRAC circuit 128. In this case, the cut-off frequency of the HPF 124 is set to 0.6% of the clock frequency. However, when the removal of thermal asperity (TA correction) is not performed, the cut-off frequency is generally set to 0.5-1%.

FIG. 5 is a graph showing the output of the read head 120 in the perpendicular magnetic recording method. In FIG. 5, a dashed line indicates a case in which no asymmetry exists while a solid line indicates a case in which the asymmetry is −30%. As shown in FIG. 5, the waveform of the perpendicular magnetic recording method is different from that of the longitudinal magnetic recording method. Thus, in the perpendicular magnetic recording method, a differentiation process is needed to perform the same demodulation process as that of the longitudinal magnetic recording method.

FIG. 6 is a graph showing the output of the HPF 124 with higher cutoff frequency in the perpendicular magnetic recording method. In FIG. 6, a dashed line indicates a case in which no asymmetry exists while a solid line indicates a case in which the asymmetry is −30%. As shown in FIG. 6, in the perpendicular magnetic recording method, an approximate differential waveform can be easily obtained by increasing the cut-off frequency of the HPF 124. However, the asymmetry of the amplitude replaces the timing shift. In particular, positive peaks A and C of FIG. 6 are shifted forward while a negative peak B of FIG. 6 is shifted backward. Because of these shifts in the peaks of the signal waveform, the correction of the asymmetry by the conventional MRAC circuit may not be possible anymore.

To solve the above-described problem, an exemplary embodiment includes a method of correcting the time shift during the recording of a signal. In the conventional recording compensation circuit, a shift generated by the interaction between the write head and the medium when recording is corrected during the phase in which the signal is read. However, in an exemplary embodiment, the write compensation circuit 114 is configured such that a timing asymmetry generated in the read process is corrected during the phase the signal is recorded. That is, the asymmetry is corrected in advance. In detail, as described below, the write signal in a pulse form is corrected along a time axis. The correction along the time axis is referred to as timing correction.

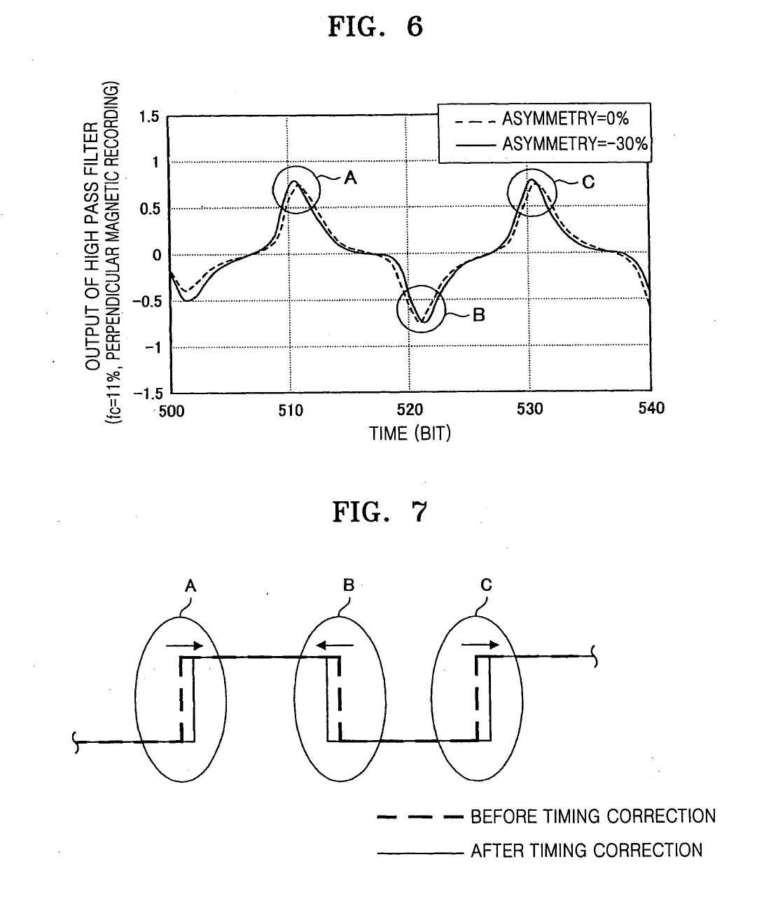

FIG. 7 is a timing diagram showing an example of the timing correction of the write compensation circuit 114. According to the example shown in FIG. 7, the asymmetry of a read signal is corrected in advance when recording on the medium 108 by correcting the timing of a rising edge and a falling edge of the write current.

Referring to FIG. 7, timing correction is performed by hastening a falling edge B of a write signal in the pulse form by a predetermined amount. By this type of a correction, the shift due to the asymmetry of −30% that is generated at the negative peak B of FIG. 6 may be prevented in advance.

Likewise, timing correction is performed by delaying a rising edge C of a write signal in the pulse form by a predetermined amount. Again, by this type of a correction, the shift due to the asymmetry of −30% that is generated at the positive peak C of FIG. 6 may be prevented in advance.

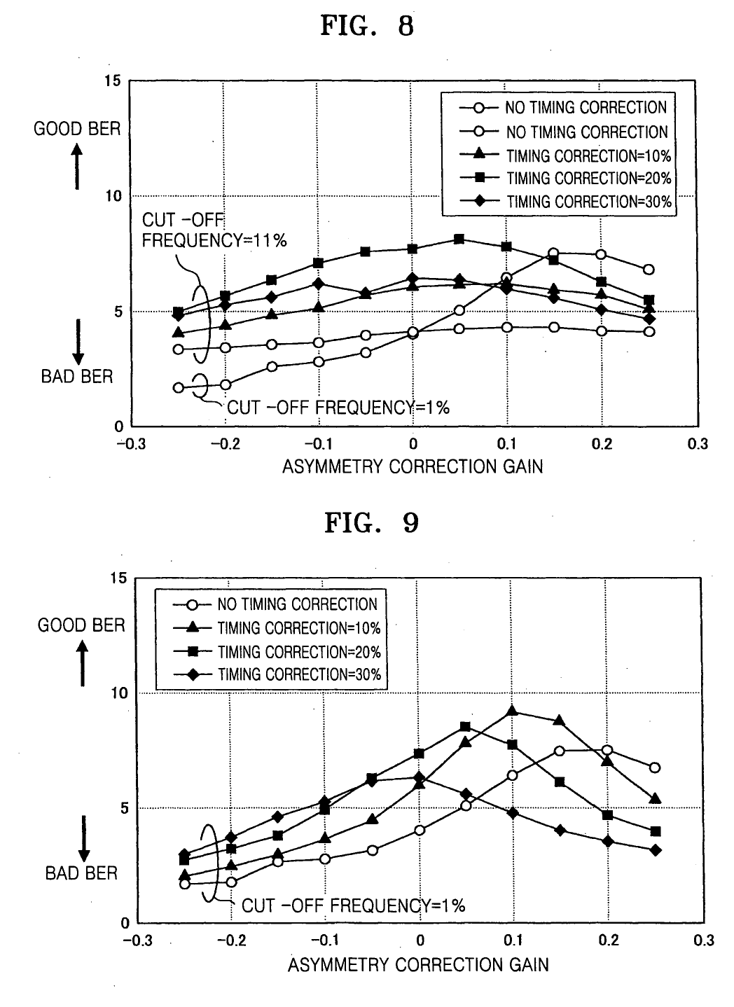

FIGS. 8 and 9 are graphs showing simulation results of the relationship between an influence of the HPF 124 and the effect of the timing correction according to an exemplary disclosed embodiment. The asymmetry correction gain of FIGS. 8 and 9 is defined as follows. When the asymmetry is defined as [(|Vₚ|−|Vₙ|)/(|Vₚ|+|Vₙ|)]×100%, wherein Vₚ is a positive peak value and Vₙ is a negative peak value, the input and output of the MRAC circuit 128 are X and Y respectively, and the asymmetry correction gain is expressed as G, the relationship between the asymmetry correction gain and the input and output of the MRAC circuit is expressed by the equation Y=X+G×X².

FIG. 8 shows cases in which the cut-off frequency of the HPF 124 is set to 11% of the clock frequency and timing correction amounts are set to 0%, 10%, 20%, and 30%. Furthermore, for comparison, a case in which the cut-off frequency of the HPF 124 is 1% and timing correction amount is 0% is shown.

As shown in FIG. 8, the BER of the case in which the cut-off frequency of the HPF 124 is 1% is improved by the asymmetry correction. However, when the cut-off frequency of the HPF 124 is 11%, the effect of the asymmetry correction is hardly evident. However, the BER can be greatly improved in this case by performing the timing correction. FIG. 8 shows that the BER is improved when timing correction amounts are set to 0%, 10%, 20%, and 30%. In particular, it can be seen that the BER is improved most when the timing correction amount is set to 20%.

FIG. 9 shows cases in which the cut-off frequency of the HPF 124 is set to 1% and timing correction amounts are set to 0%, 10%, 20%, and 30%. As shown in FIG. 9, even when the cut-off frequency of the HPF 124 is 1%, a better improvement of BER can be expected from a combination of the MRAC circuit 128 and the timing correction. At this time, it is possible to measure either the BER or parameters such as, for example, viterbi confidence information, which is indicative of the BER. Furthermore it is also possible to perform optimization while changing the combination of the asymmetry correction amount shown in the horizontal axis of the graphs of FIGS. 8 and 9, and the timing correction amount. Referring to FIG. 9, it can be seen that the BER may be improved most when the timing correction amount is 10% and the asymmetry correction amount is 10%.

Thus, as described above, when the information recorded on a medium using a perpendicular magnetic recording method is reproduced using a differential characteristic of the high pass filter, a write signal in a pulse form may be corrected in advance along the time axis (timing correction). This correction of the write signal in advance along the time axis may restrict the influence of asymmetry of the read signal and may also improve the bit error rate.

One skilled in the art will appreciate that various changes may be made to the disclosed embodiments without departing from the scope of the disclosure. For example, in the above-described embodiments, both, a rising edge and a falling edge of the write signal in FIG. 7 are corrected in time in the write compensation circuit 114. However, in alternative exemplary embodiments, only either a rising edge or a falling edge may be corrected.

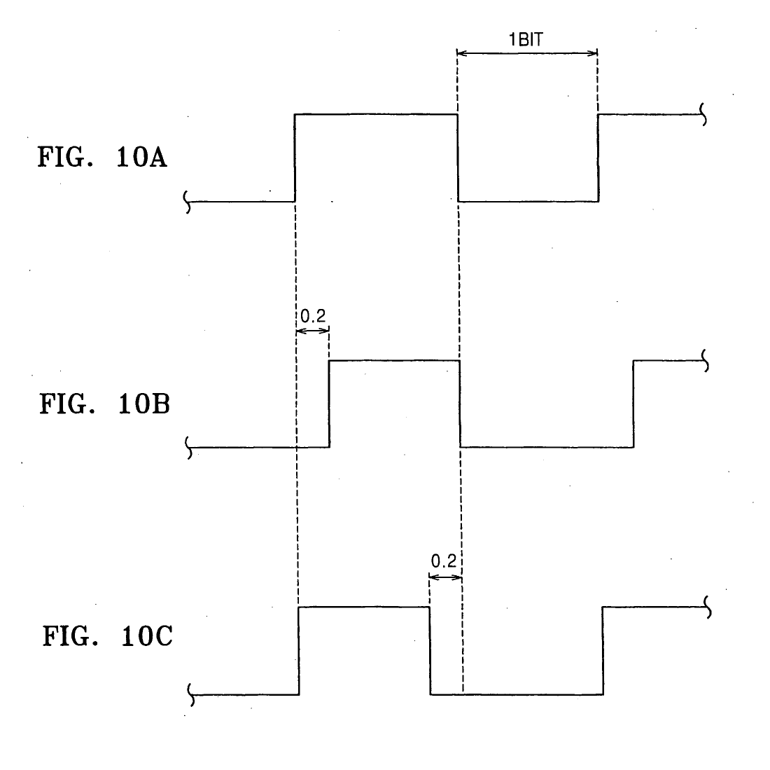

FIG. 10 includes timing diagrams showing exemplary applications of the disclosed embodiments. Specifically, FIG. 10A indicates a write signal before the timing correction. Furthermore, FIG. 10B shows a case of shifting only the rising edge by 20% of the pulse width (1 bit), while FIG. 10C shows a case of shifting only the falling edge by 20% of the pulse width (1 bit). In the hard disk drive, the self-generation of a timing signal (self-clocking) is possible and the pulse signal is relative. Therefore, the same timing correction may be performed even when the rising edge only is shifted or both rising and falling edges are shifted.

The disclosed system can be used for any information recording and reproducing apparatus such as, for example, a hard disk drive, that performs recording and reproduction of information recorded on a recording medium. In particular, the disclosed system can be used for an information recording and reproducing apparatus using a perpendicular magnetic recording medium. Also, the disclosed system can be used in other information recording and reproducing apparatuses in which a read signal has a vertical asymmetry in a rectangular shape similar to the perpendicular magnetic recording.

While the disclosed system has been particularly shown and described with reference to preferred embodiments thereof, it will be understood by those skilled in the art that various changes in form and details may be made therein without departing from the spirit and scope of the disclosure as defined by the appended claims.

What is claimed is:

1. An information recording and reproducing apparatus which records information on a medium and reproduces information stored on the medium, the apparatus comprising:
a write compensation circuit configured to perform compensation of the information recorded on the medium,
wherein the write compensation circuit corrects, in advance, an asymmetry of a signal read from the medium by correcting a write signal in a pulse form along a time axis, and an amount of correction along the time axis is based on information included in the write signal.

2. The apparatus of claim 1, wherein the write compensation circuit corrects a rising edge and a falling edge of the write signal.

3. The apparatus of claim 1, wherein the write compensation circuit corrects a rising edge of the write signal.

4. The apparatus of claim 1, wherein the write compensation circuit corrects a falling edge of the write signal.

5. An information recording and reproducing apparatus which records information on a medium and reproduces information stored on the medium, the apparatus comprising:
a write compensation circuit configured to perform compensation of the information recorded on the medium,
wherein the write compensation circuit corrects, in advance, an asymmetry of a signal read from the medium by correcting a write signal in a pulse form along a time axis.

6. The apparatus of claim 5, wherein the write compensation circuit corrects a rising edge and a falling edge of the write signal.

7. The apparatus of claim 5, wherein the write compensation circuit corrects a rising edge of the write signal.

8. The apparatus of claim 5, wherein the write compensation circuit corrects a falling edge of the write signal.

9. An information recording and reproducing apparatus which records information on a medium and reproduces information stored on the medium, the apparatus comprising:
a write compensation circuit configured to perform compensation of the information recorded on the medium; and
an MR asymmetry correction circuit configured to correct an asymmetry of a read signal from the medium,
wherein the write compensation circuit corrects, in advance, the asymmetry of the signal read from the medium by correcting a write signal in a pulse form along a time axis, an amount of correction along the time axis being based on information included in the write signal, and wherein the MR asymmetry correction circuit corrects the asymmetry of the write signal in combination with the timing correction amount.

10. The apparatus of claim 9, wherein the write compensation circuit corrects a rising edge and a falling edge of the write signal.

11. The apparatus of claim 9, wherein the write compensation circuit corrects a rising edge of the write signal.

12. The apparatus of claim 9, wherein the write compensation circuit corrects a falling edge of the write signal.

13. An information recording and reproducing apparatus which records information on a medium and reproduces information stored on the medium, the apparatus comprising:
a write compensation circuit configured to perform compensation of the information recorded on the medium; and
an MR asymmetry correction circuit configured to correct an asymmetry of a signal read from the medium,
wherein the write compensation circuit corrects, in advance, the asymmetry of the signal read from the medium by correcting a write signal in a pulse form along a time axis, and wherein the MR asymmetry correction circuit corrects the asymmetry of the write signal in combination with a timing correction amount generated from the write compensation circuit.

14. The apparatus of claim 13, wherein the write compensation circuit corrects a rising edge and a falling edge of the write signal.

15. The apparatus of claim 13, wherein the write compensation circuit corrects a rising edge of the write signal.

16. The apparatus of claim 13, wherein the write compensation circuit corrects a falling edge of the write signal.
